(19) United States
(12) Patent Application Publication
(10) Pub. No.: US 2024/0055605 A1
(43) Pub. Date: Feb. 15, 2024

(54) NEGATIVE ELECTRODE ACTIVE MATERIAL, LITHIUM ION BATTERY, AND METHOD FOR PRODUCING NEGATIVE ELECTRODE ACTIVE MATERIAL

(71) Applicant: TOYOTA JIDOSHA KABUSHIKI KAISHA, Toyota-shi (JP)

(72) Inventor: Shinsuke MATSUHARA, Miyoshi-shi (JP)

(21) Appl. No.: 18/313,466

(22) Filed: May 8, 2023

(30) Foreign Application Priority Data
Aug. 10, 2022 (JP) 2022-127923

(51) Int. Cl. H01M 4/583; H01M 10/0525; H01M 4/04; H01M 4/62

(52) U.S. Cl. CPC H01M 4/583; H01M 10/0525; H01M 4/0471; H01M 4/625; H01M 2004/027

(57) ABSTRACT

A negative electrode active material for a lithium ion battery, the negative electrode active material comprising a carbon material and a carbon film covering the carbon material, wherein the carbon material comprises carbon and boron, the content of boron in the carbon material is 0.2 atomic % or more and less than 3.5 atomic %, the negative electrode active material has an R value of 0.35 or more and 0.85 or less, and the R value is a ratio of a D band to a G band in a Raman spectrum of the negative electrode active material.

### CROSS-REFERENCE TO RELATED APPLICATION

This application claims priority to Japanese Patent Application No. 2022-127923 filed on Aug. 10, 2022 incorporated herein by reference in its entirety.

### BACKGROUND

### 1. Technical Field

The present disclosure relates to a negative electrode active material, a lithium ion battery, and a method for producing a negative electrode active material.

### 2. Description of Related Art

Japanese Unexamined Patent Application Publication No. 2021-165223 (JP 2021-165223 A) disclose that when the content of a boron element in a carbon material doped such that a carbon element is substituted with the boron element is 0.005 mol % to 15 mol %, and the content of the boron element doped such that the carbon element on the surface of the carbon material is substituted is X (mol %) and the content of the boron element in the carbon material is Y (mol %), X/Y<0.8 is obtained.

### SUMMARY

As a negative electrode active material of a lithium ion battery (hereinafter can be abbreviated as a “battery”), a carbon material such as graphite is widely used. The carbon material has electron conductivity. On the other hand, an elemental carbon material has insufficient electron conductivity. Therefore, in JP 2021-165223 A, in order to improve the electron conductivity, the carbon material is doped with boron.

However, when the carbon material is doped with boron, electrons are supplied more excessively than the ion conduction in the electrode, and thus the deposition of lithium (Li) is likely to occur. Therefore, there is room for improvement in lithium deposition resistance.

Accordingly, an object of the present disclosure is to provide a negative electrode active material having improved lithium deposition resistance.

A technical configuration and effects of the present disclosure will be described below. However, an effect mechanism of the present specification includes speculation. The effect mechanism does not limit the technical scope of the present disclosure.

One aspect of the present application provides a negative electrode active material. The negative electrode active material for a lithium ion battery includes a carbon material and a carbon film that covers the carbon material.

The carbon material includes carbon and boron,
a content of boron in the carbon material is 0.2 atomic % or more and less than 3.5 atomic %,
the negative electrode active material has an R value of 0.35 or more and 0.85 or less, and
the R value is a ratio of a D band with respect to a G band in a Raman spectrum of the negative electrode active material.

The R value is an index of crystallinity, and it indicates that the smaller the R value, the higher the crystallinity. By coating the carbon material including boron with a low-crystallinity carbon film, the electron conductivity of the surface layer of the carbon material is appropriately maintained. As a result, the supply of the electrons is suppressed from becoming excessive, and thus it is considered that the lithium deposition resistance is improved.

On the other hand, when the content of boron included in the carbon material increases, the transfer of the electrons may be inhibited by excessive boron, and the electron conductivity may be lowered. Therefore, it is considered necessary to set the content of boron within a predetermined range.

In the negative electrode active material according to the above aspect, the carbon material includes artificial graphite.

Another aspect of the present application provides a lithium ion battery. The lithium ion battery includes a negative electrode including the negative electrode active material according to the above aspect, a positive electrode, a separator, and an electrolytic solution.

Still another aspect of the present application provides a method for producing a negative electrode active material for a lithium ion battery. The method includes:
a process of obtaining a first mixture by mixing a carbon source and a boron source;
a process of producing a carbon material by firing the first mixture;
a process of obtaining a second mixture by mixing the carbon material and a precursor of a carbon film; and
a process of producing the negative electrode active material in which the carbon material is coated with the carbon film, by firing the second mixture.

A content of the boron source with respect to the carbon source is 1.5% by mass or more and 17.5% by mass or less.

In the method according to the above aspect,
a firing temperature of the first mixture is 1500° C. or higher and 3000° C. or less; and
a firing time of the first mixture is 30 minutes or more and 2 hours or less.

In the method according to the above aspect,
an average particle diameter of the carbon source is 2.5 μm or more and 1.5 μm or less; and
an average particle diameter of the boron source is 0.1 μm or more and 5.0 μm or less.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a negative electrode active material according to the present embodiment;

FIG. 2 is a schematic diagram illustrating an example of the lithium-ion battery of the present embodiment;

FIG. 3 is a schematic diagram illustrating an exemplary electrode body according to the present embodiment; and

FIG. 4 is an example of a schematic flowchart of a method for manufacturing a negative electrode active material according to the present embodiment.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

### Negative Electrode Active Material

The negative electrode active material of the present embodiment is for a lithium ion battery. Details of the lithium ion battery will be described later.

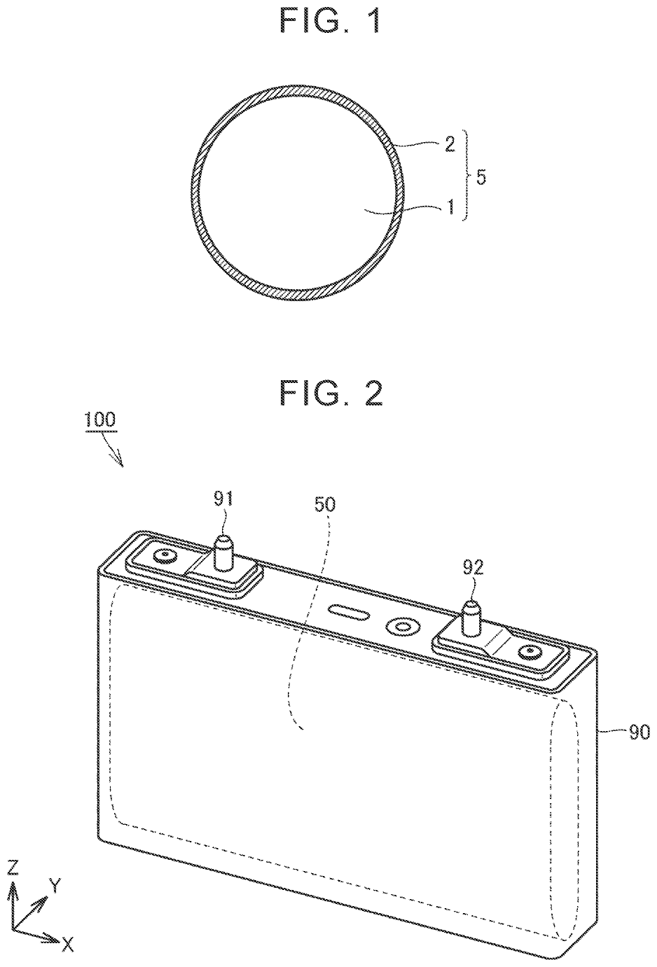

FIG. 1 is a conceptual diagram showing a negative electrode active material according to the present embodiment. The negative electrode active material 5 includes a carbon material 1 and a carbon film 2 covering the carbon material 1.

The carbon material 1 includes carbon. Examples of the carbon contained in the carbon material 1 include artificial graphite, natural graphite, soft carbon, hard carbon, carbon black (CB), carbon nanotube (CNT), and vapor-grown carbon fiber (VGCF). From the viewpoint of conductivity and cost, the carbon contained in the carbon material 1 is preferably artificial graphite or natural graphite, and more preferably artificial graphite.

The carbon material 1 includes boron. When the carbon material 1 contains boron, the electron conductivity is improved. When the carbon material 1 contains boron, durability and dispersibility of the carbon material 1 are improved. The carbon material 1 consists essentially of carbon and boron.

The boron content in the carbon material 1 is 0.2 atomic % or more and less than 3.5 atomic %. When the content of boron in the carbon material 1 is less than 0.2 atomic %, the effect of improving the electron conductivity by containing boron cannot be obtained. When the content of boron in the carbon material 1 is 3.5 atomic % or more, the transfer of electrons is inhibited by excessive boron, and the electron conductivity may be lowered. The content of boron in the carbon material 1 is preferably 0.3 atomic % or more and 3.3 atomic % or less, and more preferably 1.0 atomic % or more and 2.5 atomic % or less.

The content of boron in the carbon-material 1 is measured by X-ray photoelectron spectroscopy X-ray Photoelectron Spectroscopy (XPS). The carbon material 1 has, in XPS measured XPS spectrum, a peak top in which the binding energy (B1s) of 1s orbital of boron is in a range from 185 eV to 197 eV, and a peak top in a range from 279 eV to 298 eV in the binding energy (C1s) of is orbital of carbon. The content of boron in the carbon material 1 is 0.2 atomic % or more and less than 3.5 atomic % when the sum of the peak area of B1s spectrum and the peak area of C1s spectrum is 100 atomic %.

The carbon film 2 covers the carbon material 1. Since the carbon material 1 is covered with the carbon film 2, the electron conductivity of the surface layer of the carbon material 1 is appropriately maintained. Therefore, Li precipitation resistance is expected to be improved. The carbon film 2 may cover a part of the carbon material 1. The carbon film 2 may cover substantially all of the carbon material 1. That is, the carbon film 2 covers at least a part of the surface of the carbon material 1.

The carbon film 2 may have a thickness of, for example, 0.01 μm or more and 0.2 μm or less. When the thickness of the carbon film 2 is less than 0.01 μm, there is a possibility that the effect caused by coating the carbon material 1 with the carbon film 2 cannot be exerted. When the thickness of the carbon film 2 exceeds 0.2 μm, the resistance may be increased.

The thickness of the carbon film 2 can be measured, for example, by the following procedure. A sample is prepared by embedding the negative electrode active material 5 in a resin material. The sample is thinned by Focused Ion Beam (FIB) processing. Samples are observed according to Scanning Transmission Electron Microscope (STEM). The arithmetic average of the values measured by the plurality of negative electrode active materials 5 may be the thickness of the carbon film 2.

The carbon film 2 contains carbon. The carbon film 2 does not contain boron. The carbon film 2 may be made of, for example, substantially carbon. The carbon may comprise, for example, carbides of pitch. The content of carbon in the carbon film 2 with respect to the carbon material 1 may be, for example, 1.0 mass % or more and 10 mass % or less. When the content of carbon in the carbon film 2 with respect to the carbon material 1 is less than 1.0 mass %, the carbon film 2 may not be formed. When the content of carbon in the carbon film 2 with respect to the carbon material 1 exceeds 10 mass %, there is a possibility that carbon is aggregated and the carbon film 2 is not formed.

The negative electrode active material 5 has an R value of 0.35 or more and 0.85 or less. That is, the carbon film 2 covering the carbon material 1 has a low crystallinity structure. When the R value is less than 0.35, there is a possibility that the effect caused by coating the carbon material 1 with the carbon film 2 cannot be exerted. When the R value exceeds 0.85, the crystallinity is remarkably lowered, and since the electron supply between the negative electrode active materials 5 is not performed, the resistance may be increased. The R value is preferably 0.4 or more and 0.8 or less.

The R value is measured by Raman spectral analysis. That is, the R-value is the ratio of the Raman band (D-band) around 1360 cm⁻¹ to the Raman band (G-band) around 1580 cm⁻¹ measured by Raman spectral analysis. The R-value may also be described as I_{D}/I_{G}.

The measurement conditions by Raman spectrum analysis are as follows. However, the appropriate conditions may differ depending on the device.

[Measurement Conditions]
Laser: Argon (Ar) laser
Excitation wave length: 532 nm
Exposure time: 0.5 seconds
Number of scans: 10

The negative electrode active material 5 has, for example, a mean particle size (D50) of 1.0 μm or more and 30 μm or less. When D50 of the negative electrode active material 5 is outside the above-described range, Li precipitation resistance may be lowered. The negative electrode active material 5 preferably has a D50 of 5.0 μm or more and 20 μm or less. Here, D50 indicates a particle diameter at which the cumulative frequency from the smaller particle diameter reaches 50% in the volume-based particle diameter distribution. D50 can be measured by laser diffractometry.

### A Lithium Ion Battery

FIG. 2 is a schematic diagram illustrating an example of a lithium-ion battery according to the present embodiment. The battery 100 includes a case 90. The case 90 has any form. The case 90 may have, for example, a rectangular shape or a cylindrical shape. The case 90 may be made of metal, for example, or may be a pouch made of aluminum (Al) laminated film. The case 90 may be provided with a positive electrode terminal 91 and a negative electrode terminal 92.

The case 90 houses the electrode body 50 and the electrolytic solution. The electrolytic solution is impregnated into the electrode body 50. The electrode body 50 is connected to the positive electrode terminal 91 and the negative electrode terminal 92.

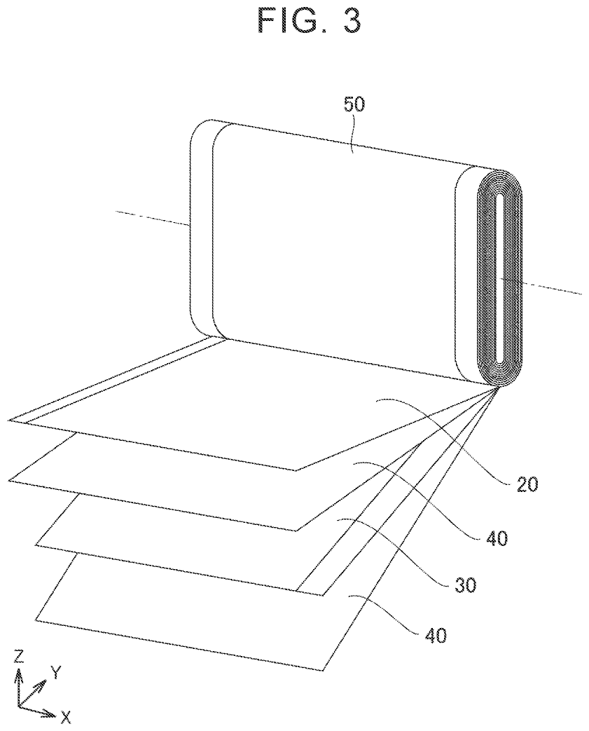

FIG. 3 is a schematic diagram illustrating an example of an electrode body according to the present embodiment. The electrode body 50 is, for example, a wound type. The electrode body 50 includes a positive electrode 20, a separator 40, and a negative electrode 30. Each of the positive electrode 20, the separator 40, and the negative electrode is a belt-shaped sheet. The electrode body 50 can be formed by laminating the positive electrode 20 and the negative electrode 30 with the separator 40 interposed therebetween and further winding in a spiral shape. Two separators 40 may be used. After winding, the electrode body 50 may be formed into a flat shape.

The electrode body 50 is, for example, a laminated type. The electrode body 50 is formed by laminating the positive electrode 20 and the negative electrode 30 via the separator 40. The electrode body 50 may have an arbitrary laminated structure as long as it includes one or more layers of the positive electrode 20, the separator 40, and the negative electrode 30. For example, the electrode body 50 may be formed by laminating the positive electrode 20, the separator 40, the negative electrode 30, the separator 40, and the positive electrode 20 in this order.

### Negative Electrode

The negative electrode 30 may include a negative electrode current collector and a negative electrode active material layer. The negative electrode current collector may include, for example, a copper (Cu) foil, a nickel (Ni) foil, or the like. The negative electrode current collector may have a thickness of, for example, 5 μm or more and 30 μm or less.

The negative electrode active material layer may have a thickness of, for example, 10 μm or more and 200 μm or less. The negative electrode active material layer includes at least the above-described negative electrode active material. The negative electrode active material layer may be made of, for example, a substantially negative electrode active material.

The negative electrode active material layer may contain, for example, a conductive material, a binder, a thickener, and the like in addition to the negative electrode active material. The conductive material may include, for example, a carbon material such as CB (acetylene black (AB), Ketjen black), graphite, or CNT, VGCF. The binder may include, for example, polyvinylidene fluoride (PVdF), polytetrafluoroethylene (PTFE), polyacrylic acid (PAA), styrene-butadiene rubber (SBR), and the like. Thickeners may include, for example, carboxymethylcellulose (CMC), methylcellulose (MC), and the like. The blending amount of the conductive material, the binder, and the thickener may be, for example, 0.1 parts by mass or more and 10 parts by mass or less with respect to 100 parts by mass of the negative electrode active material.

### Positive Electrode

The positive electrode 20 may include a positive electrode current collector and a positive electrode active material layer. The positive electrode current collector may include, for example, an aluminum (Al) foil or the like. The positive electrode current collector may have a thickness of, for example, 10 μm or more and 30 μm or less.

The positive electrode active material layer may have a thickness of, for example, 10 μm or more and 200 μm or less. The positive electrode active material layer contains at least the positive electrode active material. The positive electrode active material layer may be made of, for example, a substantially positive electrode active material. The positive electrode active material may include, for example, at least one selected from the group consisting of lithium cobaltate, lithium nickelate, lithium manganate, lithium nickel cobalt manganate and the like (for example, LiN_{1/3}Co_{1/3}Mn_{1/3}O₂), lithium nickel cobalt aluminate, and lithium iron phosphate. The positive electrode active material may be subjected to surface treatment. A buffer layer may be formed on the surface of the positive electrode active material by surface treatment. The buffer layers may comprise, for example, lithium niobate (LiNbO₃) or the like.

The positive electrode active material layer may include, for example, a conductive material, a binder, and the like in addition to the positive electrode active material. The conductive material may include, for example, a carbon material such as CB (acetylene black (AB), Ketjen black), graphite, or CNT, VGCF. The binder may include, for example, polyvinylidene fluoride (PVdF), polytetrafluoroethylene (PTFE), polyacrylic acid (PAA), styrene-butadiene rubber (SBR), and the like. The blending amount of the conductive material and the binder may be, for example, 0.1 parts by mass or more and 10 parts by mass or less with respect to 100 parts by mass of the positive electrode active material.

### Separator

The separator 40 is interposed between the positive electrode 20 and the negative electrode 30. The separator 40 spatially separates the positive electrode 20 and the negative electrode 30. The separator 40 blocks electron conduction between the positive electrode 20 and the negative electrode 30. The separator 40 is porous. The separator 40 may be made of polyolefin, for example. The separator 40 may have, for example, a single-layer structure. The separators 40 may be made of, for example, PE layers. The separator 40 may have, for example, a multilayer structure. The separator 40 may have, for example, a three-layer structure. The separators 40 may include, for example, polypropylene (PP) layers, PE layers, and PP layers. PP layers, PE layers, and PP layers may be laminated in this order. The separator 40 may have a thickness of, for example, 5 μm or more and 40 μm or less. The separator 40 may have a porosity of 30% or more and 60% or less, for example. For example, a heat-resistant layer may be formed on the surface of the separator 40. The refractory layer may comprise a refractory material such as, for example, boehmite, alumina, etc.

### Electrolytic Solution

The electrolytic solution includes a non-aqueous solvent and a supporting salt. Examples thereof include those in which a support salt is contained in a non-aqueous solvent such as an organic solvent. The non-aqueous solvent may be, for example, ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluorodimethyl carbonate (TFDMC), and the like. One solvent may be used alone, or two or more solvents may be used in combination.

The support salt is dissolved in a non-aqueous solvent. The support salt may be, for example, a lithium salt (such as LiPF₆, LiBF₄, LiAsF₆, LiClO₄, LiCF₃SO₃). One support salt may be used alone, or two or more support salts may be used in combination. The support may have, for example, a molarity of 0.5 mol/L or more and 2 mol/L or less.

The electrolytic solution may further contain an optional additive. For example, an additive having a mass fraction of 0.1% or more and 5% or less may be included. The additive may be, for example, vinylene carbonate (VC), lithium difluorophosphate (LiPO₂F₂), lithium fluorosulfonate (FSO₃Li), lithium bisoxalatoborate (LiBOB), and the like. One additive may be used alone, or two or more additives may be used in combination.

### Method for Producing Negative Electrode Active Material

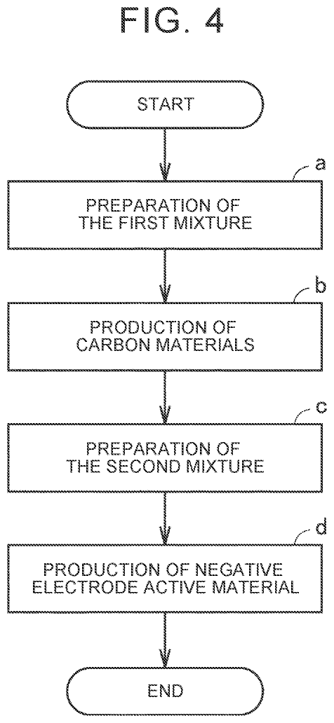

FIG. 4 is an example of a schematic flowchart of a method for manufacturing a negative electrode active material according to the present embodiment. The method for producing the negative electrode active material includes “(a) preparation of the first mixture,” “(b) production of the carbon material,” “(c) preparation of the second mixture,” and “(d) production of the negative electrode active material.” Examples of the method for producing the negative electrode active material include a gas phase method, a liquid phase method, and a solid phase method. The method for producing the negative electrode active material is merely an example, and is not limited thereto.

### (a) Preparation of the First Mixture

A method for producing a negative electrode active material includes preparing a first mixture by mixing a carbon source and a boron source.

The carbon source includes an inorganic carbon source and an organic carbon source. Examples of the inorganic carbon source include artificial graphite, natural graphite, soft carbon, hard carbon, and CB, CNT, VGCF. The organic carbon source is not particularly limited as long as it is an organic carbon raw material which is carbonized to become carbon particles after firing, which will be described later, and examples thereof include pitch, coke, brown coal, biomass, phenolic resin, polyimide resin, and polyamide resin. Of these, pitch and coke which are also used as raw materials for artificial graphite are preferable.

D50 of the carbon source may be, for example, 2.5 μm or more and 15 μm or less, and may be 5.0 μm or more and 10 μm or less.

The boron source is not particularly limited, and examples thereof include boron carbide, boron oxide, boron nitride, metal boride, boron oxoacid, and borane. For example, as the boron carbide, B₄C, B₁₂C₂ and the like, as the boron oxide, BCO₂, B₂O₂ and the like, as the boron nitride, BN and the like, as the boron nitride, AlB₂, CoB, FeB and the like, as the boron boride, orthoboric acid, metaboric acid and the like, and as the borane, monoborane, diborane and the like are exemplified.

D50 of the boron source may be, for example, 0.1 μm or more and 5.0 μm or less, and may be 0.2 μm or more and 2.0 μm or less. When D50 of the boron source is less than 0.1 μm, it is difficult to uniformly disperse the carbon source and the boron source, and there is a possibility that the desired carbon material cannot be obtained. When D50 of the boron source exceeds 5.0 μm, the contacting frequency of the carbon source and the boron source becomes low, and the desired carbon material may not be obtained.

The content of the boron source relative to the carbon source may be produced so as to be the content of boron in the carbon material described above. The amount of the boron source added to the carbon source is, for example, 1.5% by mass or more and 17.5% by mass or less, preferably 2.0% by mass or more and 15% by mass or less, and more preferably 5.0% by mass or more and 12.5% by mass or less.

The mixing method of the carbon source and the boron source is not particularly limited, and may be dry mixing or wet mixing.

### (b) Production of Carbon Materials

A method for producing a negative electrode active material includes producing a carbon material by firing a first mixture. “(a) Preparation of the first mixture” and “(b) Preparation of the carbon material” may be performed simultaneously.

The firing conditions of the first mixture vary depending on the type and amount of the carbon source and the boron source used. The firing temperature may be, for example, 1500° C. or higher and 3000° C. or lower, and may be 2000° C. or higher and 3000° C. or lower. The firing time may be, for example, 30 minutes or more and 120 minutes or less, and may be 60 minutes or more and 90 minutes or less. The atmosphere in the calcination may be carried out in air, or may be carried out in an inert atmosphere such as nitrogen, Ar, etc. In addition, the calcination may be performed in one stage with constant temperature, time, and atmosphere, or may be performed in multiple stages with changes in temperature, time, and atmosphere.

### (c) Preparation of the Second Mixture

A method for producing a negative electrode active material includes mixing a carbon material and a precursor of a carbon film, and preparing a second mixture.

Examples of the precursor of the carbon film include the same as those of the carbon source described above. The content of the precursor of the carbon film may be as long as it can be produced so as to have the above-described R value. The amount of the precursor of the carbon film added to the first mixture may be, for example, 1.0% by mass or more and 15% by mass or less, and may be 5.0% by mass or more and 10% by mass or less.

### (d) Production of Negative Electrode Active Material

A method for producing a negative electrode active material includes firing a second mixture to produce a negative electrode active material in which a carbon material is coated with a carbon film. “(c) Preparation of the second mixture” and “(d) Preparation of the negative electrode active material” may be performed simultaneously.

The firing conditions of the second mixture vary depending on the type and amount of the precursor of the carbon film to be used. The firing temperature may be, for example, 500° C. or higher and 2000° C. or lower, and may be 1000° C. or higher and 1500° C. or lower. The firing time may be, for example, 30 minutes or more and 120 minutes or less, and may be 60 minutes or more and 90 minutes or less. The atmosphere in the calcination may be carried out in air, or may be carried out in an inert atmosphere such as nitrogen, Ar, etc. In addition, the calcination may be performed in one stage with constant temperature, time, and atmosphere, or may be performed in multiple stages with changes in temperature, time, and atmosphere.

Hereinafter, the present embodiment will be described using the present example, but the present embodiment is not limited thereto.

### Example 1

### Negative Electrode Active Material

Coke (D50: 7 μm) was prepared as the carbon source and boron carbide (B₄C) as the boron source (D50: 0.5 μm), respectively. The coke and B₄C were mixed so that the weight of B₄C relative to the coke was 5.0% by weight to obtain a first blend. The first mixture was calcined at 2900° C. for one hour to produce a carbon material. The boron content in the carbon-material was measured by XPS. The results are shown in Table 1. In Examples 2 to 4 and Comparative Examples 3 to 6 described later, the content of boron in the carbon material is measured in the same manner.

A coal tar pitch was prepared as a precursor of the carbon film. The carbon material and the coal tar pitch were mixed so that the mass of the coal tar pitch with respect to the carbon material was 5.0 mass %, and a second mixture was obtained. The second mixture was fired at 1000° C. for 1 hour to produce a negative electrode active material having a carbon film formed on a carbon material. The R value was measured by the above-described measurement method and measurement conditions. D50 of the negative electrode active material was also measured. The results are shown in Table 1. In Examples 2 to 4 and Comparative Examples 1 to 6 described later, the R-value and D50 are measured in the same manner.

### Negative Electrode

A Cu foil (thickness: 10 μm) was prepared as a negative electrode current collector, SBR was prepared as a binder, CMC was prepared as a thickener, and N-methyl-2-pyrrolidone (NMP) was prepared as a dispersing medium. A negative electrode slurry was prepared by mixing the negative electrode active material, the binder, the thickener, and the dispersion medium. The mixing ratio (mass ratio) of the negative electrode active material, the binder, and the thickener was 98:1:1. The negative electrode slurry was applied to the surface of the negative electrode current collector and dried to form a negative electrode active material layer. A negative electrode was manufactured by compressing the negative electrode active material layer.

### Positive Electrode

A Al foil (thickness: 15 μm) was prepared as a positive electrode current collector, Li(Ni_{1/3}Co_{1/3}Mn_{1/3})O₂, AB as a conductive material, PVdF as a binder, and NMP as a dispersing medium. A positive electrode slurry was prepared by mixing a positive electrode active material, a conductive material, a binder, and a dispersion medium. The mixing ratio (mass ratio) of the positive electrode active material, the conductive material, and the binder was 92:5:3. The positive electrode slurry was applied to the surface of the positive electrode current collector and dried to form a positive electrode active material layer. The positive electrode was manufactured by compressing the positive electrode active material layer.

### Separator

A separator (porous membrane) having a thickness of 24 μm was prepared. The separator has a three-layer structure. The three-layer structure is formed by laminating a porous layer made of PP, a porous layer made of PE, and a porous layer made of PP in this order. Alumina (thickness: 4 μm) is applied to one side of the separator as a heat-resistant material.

### Electrolytic Solution

Mixed solvents were prepared by mixing EC, DMC and EMC. The mixing ratio (volume ratio) of EC to DMC to EMC was 3:3:4. An electrolytic solution was prepared by 1.0 mol/L dissolving LiPF₆ in solvents.

### A Lithium Ion Battery

The positive electrode, the separator, and the negative electrode were laminated in this order to form an electrode body. The surface of the separator coated with alumina is laminated so as to face the positive electrode. As a case, a pouch made of laminate film was prepared. The electrode body was housed in the case. An electrolytic solution was injected into the case. After the electrolytic solution was injected, the case was sealed. The battery of Example 1 was manufactured by performing initial charging at intervals of 3 hours or more, and then performing aging under an environment of 60° C. for 20 hours. Note that “aging” indicates that the battery is stored for a predetermined period of time in a temperature environment exceeding normal temperature.

### Example 2

A negative electrode active material was produced in the same manner as in Example 1, except that coke and B₄C were mixed so that the weight of B₄C relative to coke was 7.0 wt %. Thereafter, the battery of Example 2 was manufactured in the same manner as in Example 1.

### Example 3

A negative electrode active material was produced in the same manner as in Example 1, except that coke and B₄C were mixed so that the weight of B₄C relative to coke was 10% by weight. Thereafter, the battery of Example 3 was manufactured in the same manner as in Example 1.

### Example 4

A negative electrode active material was produced in the same manner as in Example 1, except that coke and B₄C were mixed so that the weight of B₄C relative to coke was 15% by weight. Thereafter, the battery of Example 4 was manufactured in the same manner as in Example 1.

### Example 5

A negative electrode active material was produced in the same manner as in Example 1, except that B₄C (D50: 1.5 μm) was used as the boron source, and B₄C was mixed with the coke so that the weight of B₄C relative to the coke was 10% by weight. Thereafter, the battery of Example 5 was manufactured in the same manner as in Example 1.

### Example 6

A negative electrode active material was produced in the same manner as in Example 1, except that coke and B₄C were mixed so that the weight of B₄C relative to coke was 7.0% by weight at the point that the firing temperature of the first mixture was 2300° C. Thereafter, the battery of Example 6 was manufactured in the same manner as in Example 1.

### Comparative Example 1

Coke (D50: 7 μm) was prepared as a carbon source. Artificial graphite, which is a negative electrode active material, was produced by calcining coke at 2900° C. for one hour. Thereafter, the battery of Comparative Example 1 was manufactured in the same manner as in Example 1.

### Comparative Example 2

The negative electrode active material was produced in the same manner as in Example 1 except that the artificial graphite produced in Comparative Example 1 was used as the carbon material. Thereafter, the battery of Comparative Example 2 was manufactured in the same manner as in Example 1.

### Comparative Example 3

The carbon material prepared in Example 1 was prepared as the negative electrode active material. Thereafter, the battery of Comparative Example 3 was manufactured in the same manner as in Example 1.

### Comparative Example 4

The carbon material prepared in Example 2 was prepared as the negative electrode active material. Thereafter, the battery of Comparative Example 4 was manufactured in the same manner as in Example 1.

### Comparative Example 5

A negative electrode active material was produced in the same manner as in Example 1, except that coke and B₄C were mixed so that the weight of B₄C was 1.0 wt % with respect to coke. Thereafter, the battery of Comparative Example 5 was manufactured in the same manner as in Example 1.

### Comparative Example 6

A negative electrode active material was produced in the same manner as in Example 1, except that coke and B₄C were mixed so that the weight of B₄C relative to coke was 18% by weight. Thereafter, the battery of Comparative Example 5 was manufactured in the same manner as in Example 1.

### Evaluation

Batteries were charged and discharged at −10° C. and state of charge (SOC) 60%, 15 C rates, and their capacities after one cycle of charge and discharge and after 500 cycles were measured. The rest time per cycle was 10 minutes. Capacity retention was measured by dividing the capacity after 500 cycles by the capacity after 1 cycle. The higher the storage capacity, the higher Li precipitation resistance. The results of the capacity retention ratio are shown in Table 1 as relative values of the capacity retention ratios obtained in the batteries of each example or each comparative example on the basis of the capacity retention ratios obtained in the batteries of Comparative Example 1. Note that “C” is a unit of the current rate. “1 C” refers to the current rate at which SOC reaches from 0% to 100% upon one hour of charge.

TABLE 1

| | | | | | Negative | | BATTERY |
|---|---|---|---|---|---|---|---|
| | | | | | electrode active | | Li |
| | | Boron | | Carbon | material | | precipitation |
| | | | Content | film | R | D50 | resistance |
| | | Existence | (atomic %) | Existence | value | (μm) | ^{*1}(%) |
| Examples | 1 | Y | 0.3 | Y | 0.4 | 8 | 1.03 |
| | 2 | Y | 1.1 | Y | 0.5 | 8 | 1.05 |
| | 3 | Y | 2.1 | Y | 0.8 | 8 | 1.07 |
| | 4 | Y | 3.3 | Y | 0.7 | 8 | 1.02 |
| | 5 | Y | 2.2 | Y | 0.6 | 8 | 1.04 |
| | 6 | Y | 1.2 | Y | 0.8 | 9 | 1.06 |
| Comparative | 1 | None | — | None | 0.2 | 8 | 1.00 |
| Example | 2 | None | — | Y | 0.4 | 8 | 0.98 |
| | 3 | Y | 0.3 | None | 0.3 | 8 | 0.96 |
| | 4 | Y | 1.1 | None | 0.3 | 8 | 0.94 |
| | 5 | Y | 0.1 | Y | 0.3 | 8 | 0.99 |
| | 6 | Y | 3.5 | Y | 0.6 | 9 | 0.97 |

^{*1}The value of Comparative Example 1 is set to 1

### Results

Examples 1 to 6 had a higher capacity retention ratio and improved Li precipitation resistance than Comparative Example 1.

On the other hand, in Comparative Example 2 in which a carbon material containing no boron was used, and in Comparative Examples 3 and 4 in which a carbon material not coated with a carbon film was used, Li deposition resistance decreased. It is considered that Li precipitation resistance is not improved only by coating the carbon material containing no boron with the carbon film and by only the carbon material containing boron.

Further, Comparative Examples 5 and 6 in which the content of boron in the carbon-material was 0.1 atomic % and 3.5 atomic %, Li precipitation resistance was lowered. It is believed that the content of boron in the carbon material also has a suitable range.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. A negative electrode active material for a lithium ion battery, the negative electrode active material comprising a carbon material and a carbon film that covers the carbon material, wherein:
the carbon material includes carbon and boron;
a content of boron in the carbon material is 0.2 atomic % or more and less than 3.5 atomic %;
the negative electrode active material has an R value of 0.35 or more and 0.85 or less; and
the R value is a ratio of a D band with respect to a G band in a Raman spectrum of the negative electrode active material.

2. The negative electrode active material according to claim 1, wherein the carbon material includes artificial graphite.

3. A lithium ion battery comprising a negative electrode including the negative electrode active material according to claim 1, a positive electrode, a separator, and an electrolytic solution.

4. A method for producing a negative electrode active material for a lithium ion battery, the method comprising:
a process of obtaining a first mixture by mixing a carbon source and a boron source;
a process of producing a carbon material by firing the first mixture;
a process of obtaining a second mixture by mixing the carbon material and a precursor of a carbon film; and
a process of producing the negative electrode active material in which the carbon material is coated with the carbon film, by firing the second mixture, wherein
a content of the boron source with respect to the carbon source is 1.5% by mass or more and 17.5% by mass or less.

5. The method according to claim 4, wherein:
a firing temperature of the first mixture is 1500° C. or higher and 3000° C. or less; and
a firing time of the first mixture is 30 minutes or more and 2 hours or less.

6. The method according to claim 4, wherein:
an average particle diameter of the carbon source is 2.5 μm or more and 1.5 μm or less; and
an average particle diameter of the boron source is 0.1 μm or more and 5.0 μm or less.
